(19) United States
(12) Patent Application Publication
(10) Pub. No.: US 2014/0217954 A1
(43) Pub. Date: Aug. 7, 2014

(54) SHINE ON SOLAR TABLE

(71) Applicant: Nancy K. Wilde, Vernon (CA)

(72) Inventor: Nancy K. Wilde, Vernon (CA)

(21) Appl. No.: 14/171,913

(22) Filed: Feb. 4, 2014

Related U.S. Application Data
(60) Provisional application No. 61/760,486, filed on Feb. 4, 2013.

(51) Int. Cl. A47B 37/04; H02J 7/35; H02J 7/00

(52) U.S. Cl. CPC A47B 37/04; H02J 7/0042; H02J 7/0052; H02J 7/35
USPC 320/101

(57) ABSTRACT

A table is disclosed that uses a built-in solar panel to collect and store electrical energy. The table uses the solar panel as part of the table top. The table includes electrical outlets for both 12-volt DC power and 110-volt AC power.

### RELATED APPLICATION

The present application claims the benefit of U.S. Provisional Application No. 61/760,486 filed Feb. 4, 2013, which is incorporated herein in its entirety by reference.

### FIELD OF THE INVENTION

The present invention relates in general to a table having a horizontally mounted integrated solar power supply.

### BACKGROUND OF THE INVENTION

Tables are commonly used for outdoor entertaining and dining Objects requiring a power source are often used outside in an environment where electric power is not readily available. Using extension cords can be inconvenient or even unsafe; or totally not possible due the proximity of an external power source. The solar powered table allows access to a readily available source of electrical power to run laptops, charge cell phones and cameras or operate small appliances such as lamps, coffee makers, battery powered tool charger and panini machines as examples.

### SUMMARY OF THE INVENTION

This invention introduces a table and method which do not require access to a conventional AC wall outlet. The apparatus and method of the present invention provides a solar energy collection device horizontally mounted in the top of the table and forming part of the table top, converts solar energy to an electrical DC voltage. The base station is housed in an aluminum under-pan mounted to the underside of the tabletop and solar panel. The base station consists of one or more batteries that store the DC voltage and an inverter that converts the DC voltage to AC voltage. Power outlet terminals mounted on either side of the aluminum under-pan receives 110 volts of AC power from the inverter, or 12 volts of DC power direct from the batteries. This allows an electrical device to be plugged into the desired terminal for power.

An aspect of an embodiment of the invention provides electricity to external electrical devices from solar energy collected from solar energy collection devices located in the tabletop.

A further aspect of an embodiment of the invention provides a power switch that can disconnect the inverter of the apparatus in the event of an emergency.

An aspect of an embodiment of the invention provides the option of using an external power source to charge the batteries in addition to the solar panel, should the need arise.

Additional aspect objective features and advantages of the present invention will become apparent from the following description of the preferred embodiment with reference to the attached drawings.

### BRIEF DESCRIPTION OF THE DRAWINGS

FIG. 1 is a perspective view of the table and solar energy collection device.

FIG. 2 is a side view of the table and aluminum under-pan, including 12 volt and 110 volt terminals as well as venting of the under-pan.

FIG. 3 is a side view, opposite to FIG. 2, of the table and the aluminum under-pan, including 12 volt and 110 volt terminals as well as the external charge or solar panel switch and external charge terminals.

FIG. 4 is an end view of the table and under-pan, including the inverter on/off switch and the battery charge level gauge.

FIG. 5 is a wiring schedule of the electrical system of the table.

FIG. 6 is the wiring diagram for the electrical system of the table.

### DETAILED DESCRIPTION OF THE DRAWINGS

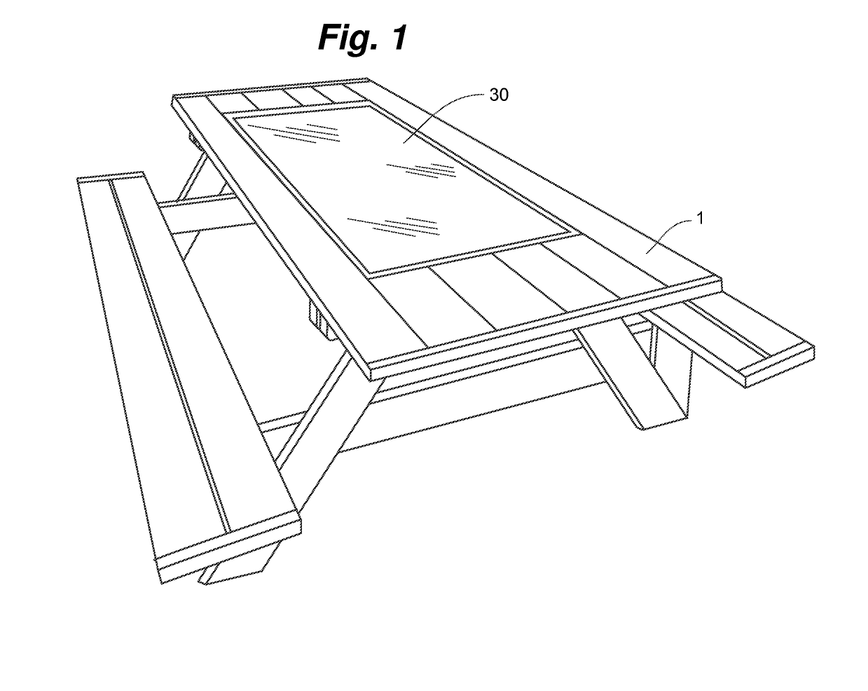

FIG. 1 is a perspective view of the table 1 and the solar energy collection device 30 that converts solar energy to an electrical DC voltage charge. The table shown in FIG. 1 could be considered a conventional style of picnic table; however, the style of table can be configured in different ways such as a coffee table or a bistro style table. The table 1 can be constructed of any material capable of supporting the solar collection device 30, the aluminum under-pan 13 and the electrical system of the table apparatus. The solar energy collection device 30 is groups of solar cells in the form of a panel designed to absorb the sun's rays as a source of energy for generating electricity. The panel 30 is positioned in the table top which can be positioned to receive maximum exposure to the sun. The under-pan 13 is supported in the table top under the solar energy collection device 30. The under-pan 13 houses the electrical charging/storage base station and is sealed and protected from the weather and movement without damaging the apparatus. All electrical connections and components are housed in the aluminum under-pan 13.

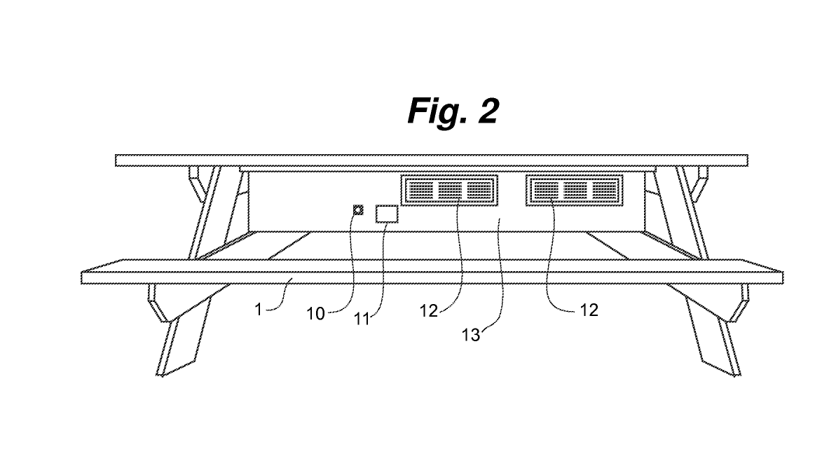

FIG. 2 is a perspective side view of the table 1 and aluminum under-pan 13 including 12 volt 10 and 110 volt 11 terminals as well as venting 12 of the under-pan 13. The venting 12 is positioned in such a way as to provide air circulation and cooling for the inverter 20 and batteries 21.

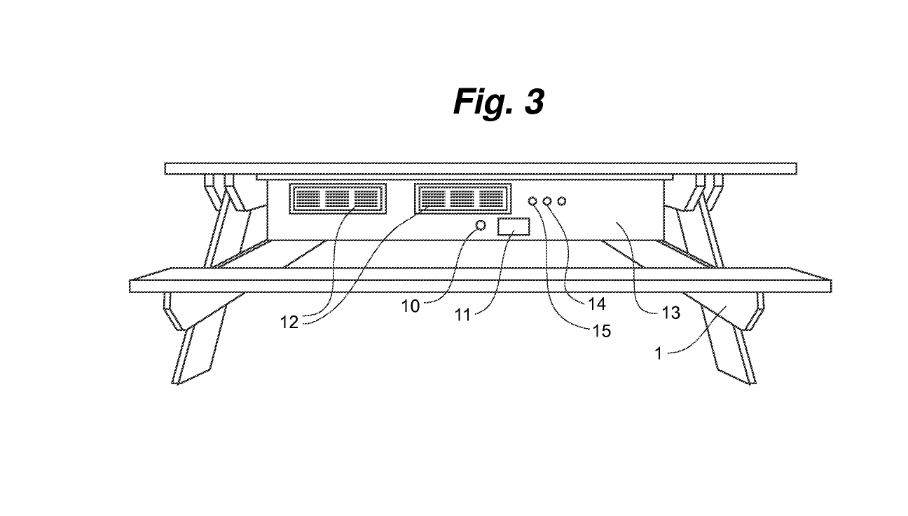

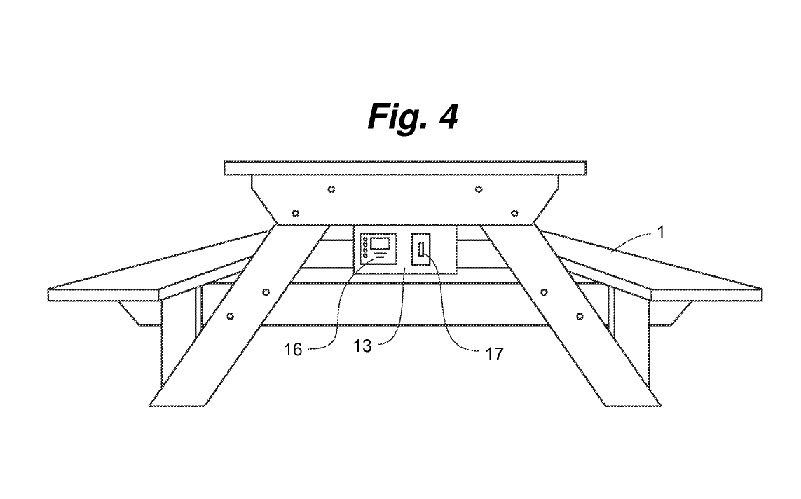

FIG. 3 is a perspective side view of the table 1 and aluminum under-pan 13 including 12 volt 10 and 110 volt 11 terminals as well as venting 12 of the under-pan 13, as well as the external charge or solar panel switch 15 and the external charge terminals 14. The venting 12 is positioned in such a way as to provide air circulation and cooling for the inverter 20 and batteries 21. FIG. 4 is a perspective end view of the table 1 and under-pan 13, including the inverter on/off switch 17 and the battery charge level gauge 16. The battery charge level gauge 16 displays the solar energy collection device 30 charging current or state of current charge or rate of current charge or a current discharge. The battery charge level gauge 16 may be LED or LCD or a light indicator depicting the level of charge in the batteries 21 as well as when the batteries 21 were last fully charged in terms of days. The on/off switch 17 activates the inverter to allow power to the 110 volt 11 terminals.

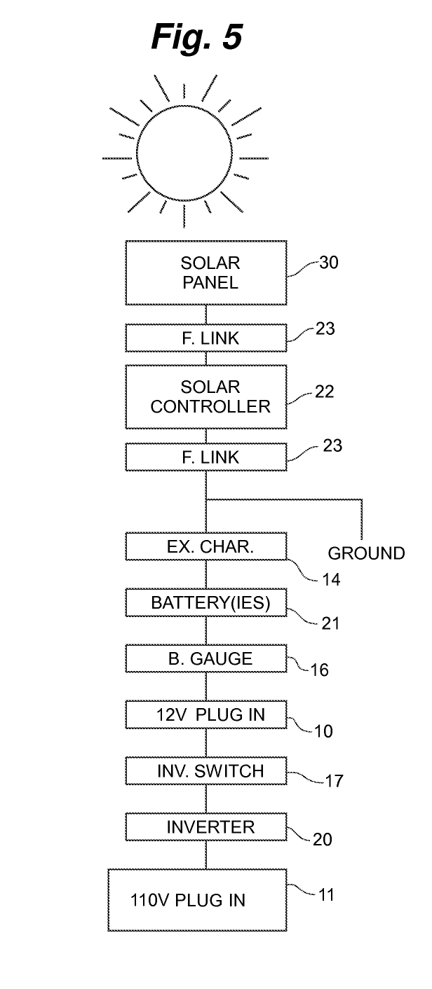

FIG. 5 is a wiring schedule of the electrical system of the table 1. This system provides power to electrical devices requiring an AC 110 volt terminal 11 and DC 12 volt terminal 10. The electrical system is housed in the aluminum under-pan 13. In the event of any needed servicing or repair, lifting the solar energy collection device 30 will provide access to the electrical system components and the inverter 20. In use the solar collection device 30 collects energy from the sun and converts the energy into an electrical charge that is stored in the batteries 21. The battery charge controller 22 maintains the proper charging voltage for the batteries 21. The batteries 21 store the energy provided by the solar panel 30. The solar panel 30 supply energy which is regulated by the battery charge controller 22 to the 12 volt deep cycle gel batteries 21 which sends 12 volt DC to a power inverter 20. The sine waver power inverter 20 converts a DC voltage output from the storage batteries 21 to 110 volt AC. The 12 volt DC power terminals 10 are supplied by power direct from the batteries 21. The power outlets 11 are terminals, which allow 110 volt AC powered devices to access the output of the sine wave power inverter 20. The battery charge controller 16 maintains the proper charging voltage for the batteries 21. The batteries 21 store the energy provided by the solar panels 30. The control system features fuseable links 23 which allow electrical current to pass through the circuit. An unwanted short circuit causes the fuseable link 23 to short out and act as an over current protection device. The fuseable link 23 is a metal strip that melts when too much current flows, this interrupts the circuit in which it is connected. The 110 volt AC terminals 10 are also GFCI protected. A GFCI ground fault circuit interrupter protected outlet will cause an internal breaker in the outlet to trip if it senses more than 0.5 amp variance in the electrical current, this will protect the user from electrical shock or electrocution.

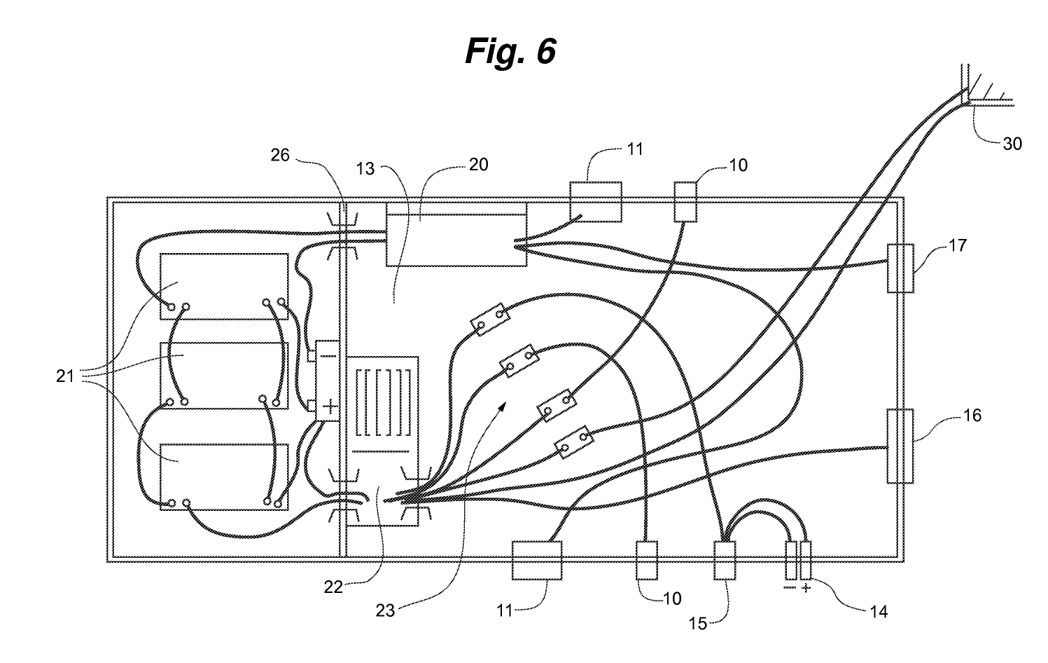

FIG. 6 is the wiring diagram for the electrical system of the table, and the same comments attributed FIG. 5 apply. In addition, FIG. 6 shows a metal divider 26 that separates the batteries 21 from the rest of the electrical system in the under-pan 13. This is required to mitigate the possibility of arcing of the batteries 21 with any of the other electrical components in the system as well as confining and venting any gases produced by the batteries 21.

The invention has been described in detail with particular reference to certain preferred embodiments, but it will be understood that variations and modifications can be effected within the scope of the invention.

1. An electrical energy generating and storing table comprising:
a top surface;
a horizontal photovoltaic panel with a top surface substantially coplanar with the top surface of the table;
a power module comprising:
a direct current battery;
a battery charge controller;
a sine wave power inverter;
a 110-volt power outlet terminal; and
an inverter switch;
wherein the power module is contained within an underpan.

2. The table of claim 1 further comprising a seating surface incoplanar to the top surface.

3. The table of claim 2 further comprising a 12-volt power outlet terminal and wherein the direct current battery comprises a 12-volt deep cycle gel battery.

4. The table of claim 3 further comprising fuseable links electrically isolating the photovoltaic panel from the battery charge controller.

5. The table of claim 3 wherein the 110-volt power outlet terminal comprises a ground fault circuit interrupter.

6. The table of claim 3 further comprising a 12-volt power outlet terminal.

7. The table of claim 3 further comprising trickle charge terminals in electrical communication with the battery charge controller.

8. The table of claim 7 further comprising a toggle switch between the trickle charge terminals and the battery charge controller.

9. The table of claim 3 further comprising a divider in the underpan that physically isolates the battery from the battery charge controller, the sine wave power inverter, the 110-volt power outlet terminal, and the inverter switch.

10. The table of claim 9 further comprising a ventilation port in the underpan.

11. A power generating table comprising:
a table top comprising:
a table surface;
a solar panel having a top surface, the top surface being substantially coplanar with the table surface;
wherein a surface area of the solar panel top surface is greater than a surface area of the table surface;
a base comprising:
a battery;
a battery charge controller;
a sine wave power inverter;
a 110-volt power outlet terminal;
an inverter switch; and
an underpan.

12. The table of claim 11 further comprising a 12-volt power outlet terminal.

13. The table of claim 11 further comprising a 12-volt power outlet terminal and wherein the battery comprises a 12-volt deep cycle gel battery.

14. The table of claim 12 further comprising trickle charge terminals in electrical communication with the battery charge controller.

15. The table of claim 14 further comprising a toggle switch between the trickle charge terminals and the battery charge controller.

16. The table of claim 13 further comprising a sitting surface.

17. A solar energy collecting article of furniture comprising:
a table top defining a table top surface area;
a solar panel inserted within the table top; defining a solar panel surface area wherein an upper plane of the solar panel is coplanar to an upper plane of the table top;
wherein the solar panel surface area is greater than the table top surface area;
a direct current battery;
a battery charge controller;
a power inverter;
a 110-volt power outlet terminal;
an inverter switch; and
an underpan.

18. The table of claim 17 further comprising a sitting surface incoplanar to the upper plane of the table top.

19. The table of claim 17 wherein the power inverter is a sine wave power inverter.

20. The table of claim 17 further comprising trickle charge terminals in electrical communication with the battery charge controller
